(19) United States
(12) Patent Application Publication
(10) Pub. No.: US 2026/0110190 A1
(43) Pub. Date: Apr. 23, 2026

(54) HANDLE ASSEMBLY AND SYSTEM

(71) Applicant: ASSA ABLOY AB, Stockholm (SE)

(72) Inventor: Harald Vestøl, Kolbotn (NO)

(21) Appl. No.: 19/118,029

(22) PCT Filed: Sep. 27, 2023
(86) PCT No.: PCT/EP2023/076711

§ 371 Date: Apr. 3, 2025

(30) Foreign Application Priority Data
Oct. 11, 2022 (SE) 2251190-1

(51) Int. Cl. E05B 3/06; E05B 63/04

(52) U.S. Cl. CPC E05B 3/065; E05B 63/04

(57) ABSTRACT

A handle assembly (12a, 12b) comprising a base structure (26a, 26b) for fixation to an access member (18a, 18b); a handing element (38a, 38b); a spring (40a, 40b); and a handle (28a, 28b); wherein the handing element is rotatable relative to the base structure about a rotation axis (30) together with the spring and the handle between a first handing position (54a) and a second handing position (54b); wherein the handle is rotatable relative to the handing element about the rotation axis against a deformation of the spring when the handing element is in the first handing position and in the second handing position; and wherein the base structure comprises a first stop (48a) arranged to be engaged by the handing element to define the first handing position and a second stop (48b) arranged to be engaged by the handing element to define the second handing position.

### TECHNICAL FIELD

The present disclosure generally relates to handles for door leaves or similar. In particular, a handle assembly and a system comprising two handle assemblies, are provided.

### BACKGROUND

There are four different types of handings of a door leaf, namely right hand (RH), left hand (LH), right hand reverse (RHR) and left hand reverse (LHR). Some prior art lock systems rely on dedicated components in dependence of the handing of the door leaf. In other words, the hardware for a lock system for a first type of handing differs from the hardware for a lock system for a second type of handing. This makes it necessary to produce a relatively high number of components and to provide storage for these components. Moreover, customers may not always know the handing of the door leaf when ordering the lock system.

In order to avoid producing a dedicated handle assembly for each type of handing, a handle may be positioned in a desired position during installation to thereby provide a particular handing. The procedure of handing a handle assembly during installation may however be complicated and there is a risk of introducing errors to the installation.

### SUMMARY

One objection of the invention is to provide an improved handle assembly.

A further object of the invention is to provide an improved system comprising two handle assemblies.

These objects are achieved by the handle assembly according to appended claim 1 and the system according to appended claim 14.

The invention is based on the realization that by providing a handle assembly having distinct stops for a handing element that is rotatable relative to a base structure to set a handing of the handle assembly, the handing can easily be set by an installer during installation with a low risk of errors and any subsequent introduction of screws is simplified.

According to a first aspect, there is provided a handle assembly comprising a base structure for fixation to an access member; a handing element; a spring; and a handle; wherein the handing element is rotatable relative to the base structure about a rotation axis together with the spring and the handle between a first handing position and a second handing position; wherein the handle is rotatable relative to the handing element about the rotation axis against a deformation of the spring when the handing element is in the first handing position and in the second handing position; and wherein the base structure comprises a first stop arranged to be engaged by the handing element to define the first handing position and a second stop arranged to be engaged by the handing element to define the second handing position.

When the handing element adopts the first handing position and the second handing position, respectively, the handle assembly adopts a first handing and a second handing, respectively. For each of the first handing and the second handing, the spring may function as a return spring for returning the handle to a neutral position after manual actuation.

The first and second stops enable the handing element to be accurately positioned in relation to remainder of the handle assembly for each handing. For example, in case the handing element comprises one or more handing holes, the handing holes can easily be aligned with one or more further holes for receiving screws therein by positioning the handing element in any of the first handing position and the second handing position. Moreover, the engagement between the handing element and any of the first and second stops enables tolerance requirements on screws and associated holes to be relaxed.

When the handing element has been positioned in any of the first handing position or the second handing position to select the first handing or the second handing, the handing element may be fixed to the base structure, e.g. by one or more screws. When the handing element is fixed to the base structure, the handle assembly may provide a two-way handle return. The handing element may be concentric with the rotation axis.

The handle assembly may be asymmetric with respect to a plane comprising the rotation axis and being aligned with the handle when the handing element is in any of the first handing position and the second handing position. The handing elements and the springs may be identic for an inside handle assembly and an outside handle assembly according to the first aspect.

The base structure may comprise a housing. The handing element and the spring may be positioned inside the base structure.

The handing element may have a substantially cylindrical, or cylindrical, shape. The handing element may have a circular outer surface. The outer surface and/or the handing element may be concentric with the rotation axis.

The spring may be a torsion spring. The spring may comprise an elongated spring element forming a two legs and a coiled portion therebetween. The coiled portion may be concentric with the rotation axis. The handing element may be arranged to engage both legs.

The handle may be elongated. When the handle assembly is installed in a door leaf, the handle may have a main extension in a horizontal plane in a neutral position for each of the first handing and the second handing.

The handing element may comprise an engaging structure arranged to engage the first stop in the first handing position and to engage the second stop in the second handing position. The engaging structure may be a protruding structure, e.g. protruding from the remainder of the engaging structure in parallel with the rotation axis.

The base structure may comprise an aperture. In this case, the handing element may be seated in the aperture.

The base structure and the handing element may form a sliding contact bearing for supporting the handing element during the rotation relative to the base structure. The sliding contact bearing may comprise the circular outer surface of the handing element and a circular inner surface of the base structure.

The handing element may be rotatable at least 150 degrees, such as 180 degrees, between the first handing position and the second handing position. For a relatively lowest degree of deformation of the spring, the handle may be aligned with the handing element in each of the first handing position and the second handing position.

The handle assembly may comprise an input member fixed to, or integrally formed with, the handle. In this case, the spring, such as the coiled portion thereof, may enclose the input member. Moreover, the handing element may enclose the spring. The input member, the spring and the handing element may form a handing mechanism package that can be rotated by the handle during installation to set the handing of the handle assembly.

The input member may be positioned inside the base structure. The input member may engage both legs of the spring. The input members may be identic for an inside handle assembly and an outside handle assembly according to the first aspect. The input member may be concentric with, and rotatable about, the rotation axis.

The base structure may comprise an escutcheon.

The base structure may comprise a cover. The cover may face the door leaf, and may optionally contact the door leaf, when the handle assembly is installed in the door leaf. The cover may be made of sheet metal.

The cover may be secured to the escutcheon.

The cover may comprise the first stop and the second stop. The covers may or may not be identic for an inside handle assembly and an outside handle assembly according to the first aspect.

The base structure may comprise a primary base hole. In this case, the handing element may comprise a first handing hole arranged to be aligned with the primary base hole in the first handing position and a second handing hole arranged to be aligned with the primary base hole in the second handing position.

The base structure may comprise a secondary base hole. In this case, the second handing hole may be arranged to be aligned with the secondary base hole in the first handing position, and the first handing hole may be arranged to be aligned with the secondary base hole in the second handing position. The first and second handing holes may be through holes or blind holes. The base holes may be through holes or blind holes.

The handing element may be arranged to engage the base structure by a snap-fit in each of the first handing position and the second handing position. The snap-fit enables the handing element to be locked in any of the first handing position and the second handing position such that the handing element is prevented from rotating about the rotation axis. As a consequence, the handing element does not necessarily have to be secured with a fastener, such as a bolt or screw, engaging a base hole. The snap-fit may be useful in an outside handle assembly for a relatively thick door leaf when a fastener passing through an inside handle assembly does not reach the outside handle assembly.

According to one example, the snap-fit comprises a seat and a tab for engaging the seat. Each tab may be provided in the handing element and each seat may be provided in the base structure, or vice versa.

The handle assembly may be configured such that the snap-fit can be manually released using a tool, such as a screwdriver. To this end, the base structure may for example comprise an opening for accessing the tab with the tool. When the snap-fit has been released, the handing of the handle can be changed by rotating the handing element. The snap-fit may for example be released during installation of the handle assembly.

According to a second aspect, there is provided a system comprising a handle assembly according to the first aspect as an inside handle assembly and a handle assembly according to the first aspect as an outside handle assembly.

The system may be a handle system. The system may comprise a lock device, such as a lock case. In this case, the system may be a lock system.

### BRIEF DESCRIPTION OF THE DRAWINGS

Further details, advantages and aspects of the present disclosure will become apparent from the following description taken in conjunction with the drawings, wherein:

FIG. 1a: schematically represents a side view of a system comprising an inside handle assembly and an outside handle assembly having first handings;

FIG. 1b: schematically represents an outside view of the outside handle assembly;

FIG. 1c: schematically represents an inside view of the inside handle assembly;

FIG. 2a: schematically represents a side view of the system when the inside handle assembly and the outside handle assembly have second handings;

FIG. 2b: schematically represents an inside view of the inside handle assembly in FIG. 2a;

FIG. 2c: schematically represents an outside view of the outside handle assembly in FIG. 2a;

FIG. 3: schematically represents a perspective outside view of the inside handle assembly having the first handing;

FIG. 4: schematically represents a partial perspective outside view of the inside handle assembly in FIG. 3;

FIG. 5: schematically represents a perspective view of a spring of the inside handle assembly;

FIG. 6: schematically represents a perspective inside view of a cover of the inside handle assembly;

FIG. 7: schematically represents a perspective outside view of an escutcheon of the inside handle assembly;

FIG. 8: schematically represents a perspective outside view of a handing mechanism comprising a handing element, the spring and an input member of the inside handle assembly;

FIG. 9: schematically represents a perspective inside view of the handing mechanism;

FIG. 10: schematically represents a partial outside view of the inside handle assembly having the second handing;

FIG. 11: schematically represents a partial perspective inside view of the outside handle assembly having the first handing;

FIG. 12: schematically represents a further partial perspective inside view of the outside handle assembly in FIG. 11;

FIG. 13: schematically represents an outside perspective view of a cover of the outside handle assembly; and

FIG. 14: schematically represents a partial perspective inside view of the outside handle assembly having the second handing.

### DETAILED DESCRIPTION

In the following, a handle assembly and a system comprising two handle assemblies, will be described. The same or similar reference numerals will be used to denote the same or similar structural features.

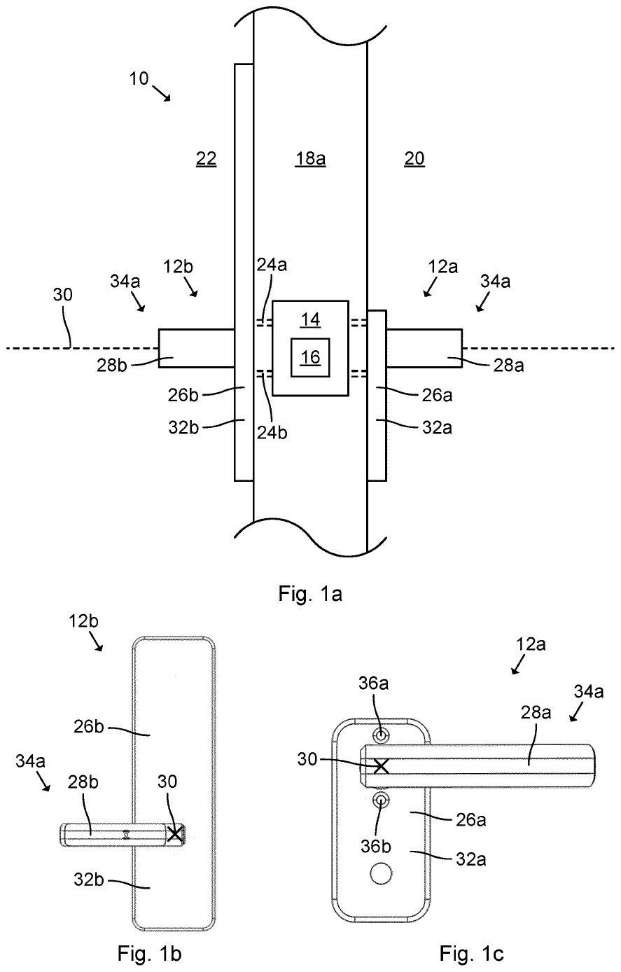

FIG. 1a schematically represents a side view of a system 10. The system 10 comprises an inside handle assembly 12a and an outside handle assembly 12b. Each of the inside handle assembly 12a and the outside handle assembly 12b is an example of a handle assembly according to the present disclosure.

The system 10 further comprises a lock device 14, here exemplified as a lock case. The lock device 14 comprises a bolt 16 for engaging a strike in a frame (not shown).

In FIG. 1a, the system 10 is installed in a door leaf 18a. The door leaf 18a is one example of an access member according to the present disclosure. The inside handle assembly 12a is positioned on an inside 20 of the door leaf 18a. The outside handle assembly 12b is positioned on an outside 22 of the door leaf 18a. The lock device 14 is received in a pocket (not denoted) in the door leaf 18a.

The system 10 of this example further comprises a first screw 24a and a second screw 24b. The screws 24a and 24b secure the inside handle assembly 12a and the outside handle assembly 12b to the door leaf 18a and the lock device 14.

The inside handle assembly 12a of this example comprises a base structure 26a fixed to the door leaf 18a and an elongated handle 28a rotatable relative to the base structure 26a about a rotation axis 30. The base structure 26a of this example comprises an escutcheon 32a. In FIG. 1a, the inside handle assembly 12a has a first handing 34a.

The outside handle assembly 12b of this example comprises a base structure 26b fixed to the door leaf 18a and an elongated handle 28b rotatable relative to the base structure 26b about the rotation axis 30. The base structure 26b of this example comprises an escutcheon 32b. As shown, the escutcheon 32b has different design than the escutcheon 32a. In FIG. 1a, also the outside handle assembly 12b has the first handing 34a.

FIG. 1b schematically represents an outside view of the outside handle assembly 12b. As shown in FIG. 1b, the outside handle assembly 12b is asymmetric with respect to a plane comprising the rotation axis 30 and being aligned with the handle 28b (a horizontal plane in FIG. 1b).

FIG. 1c schematically represents an inside view of the inside handle assembly 12a. As shown in FIG. 1c, also the inside handle assembly 12a is asymmetric with respect to a plane comprising the rotation axis 30 and being aligned with the handle 28a (a horizontal plane in FIG. 1c). The escutcheon 32a of this example comprises a primary escutcheon hole 36a and a secondary escutcheon hole 36b. As shown, the primary escutcheon hole 36a is positioned above the rotation axis 30 and the secondary escutcheon hole 36b is positioned below the rotation axis 30 in this example. The primary escutcheon hole 36a and the secondary escutcheon hole 36b are examples of a primary base hole and a secondary base hole, respectively, according to the present disclosure. The primary escutcheon hole 36a and the secondary escutcheon hole 36b of this example are through holes for receiving the first screw 24a and the second screw 24b, respectively, therethrough.

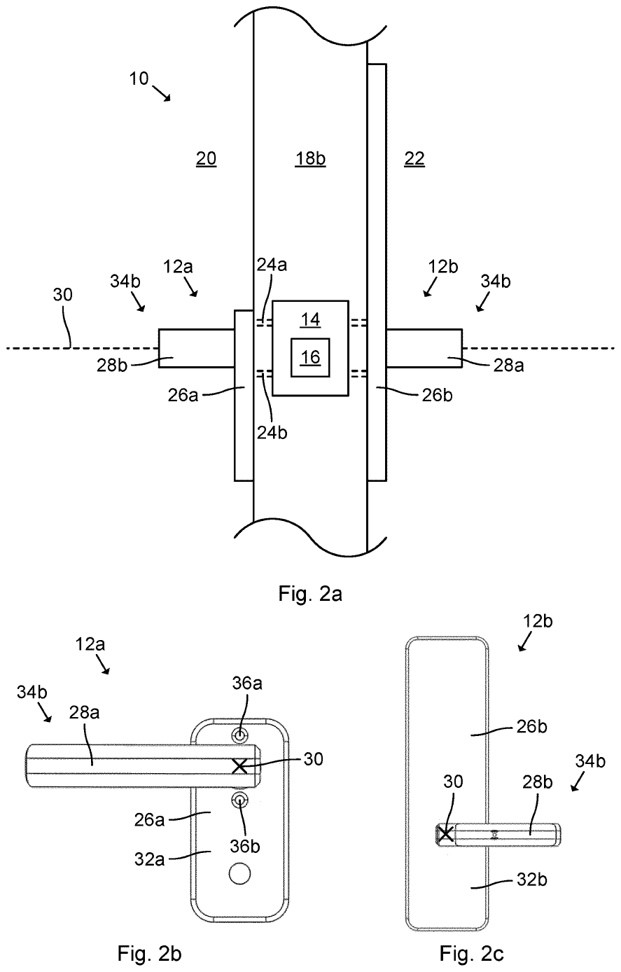

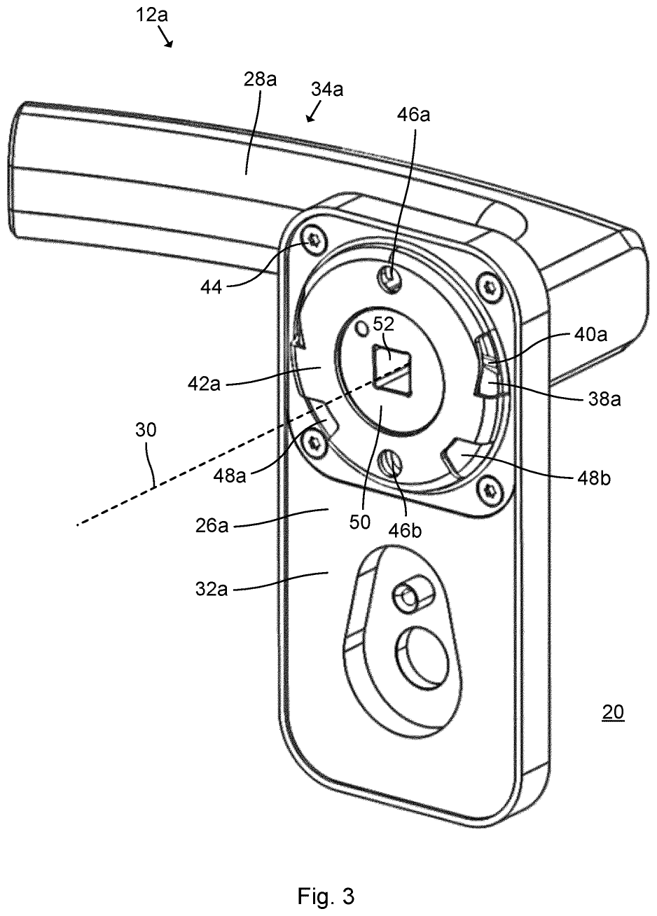

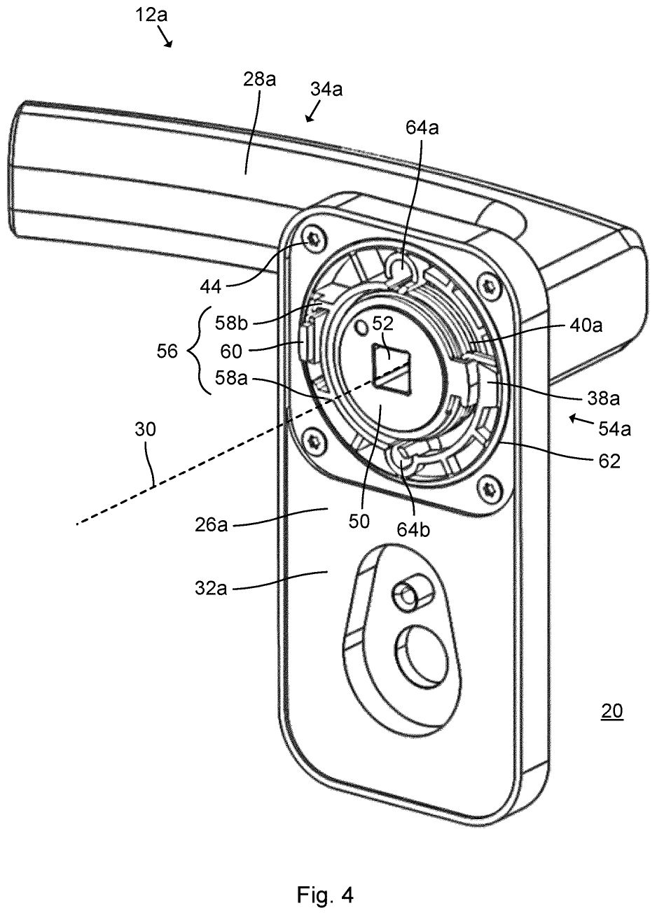

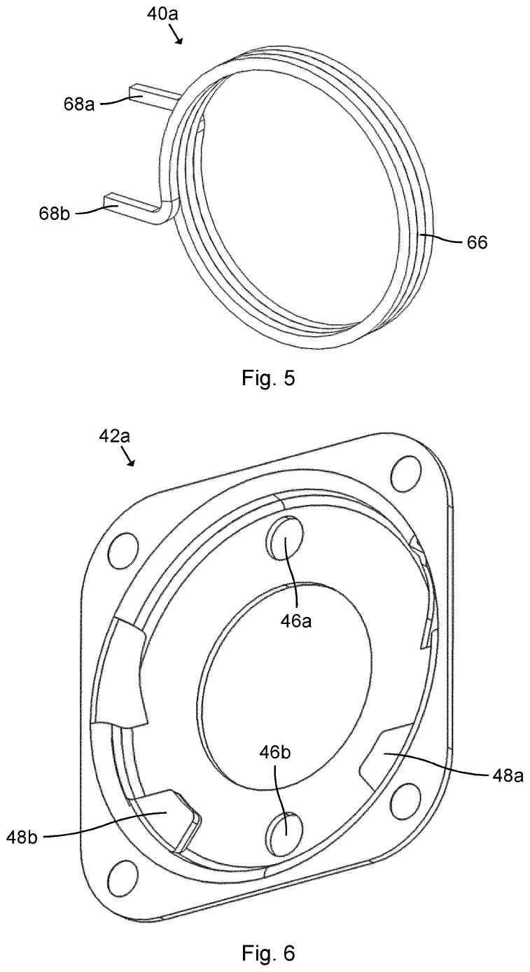

FIG. 2a schematically represents a side view of the system 10. In FIG. 2a, the system 10 is installed to a door leaf 18b, different from the door leaf 18a. The door leaf 18b is a further example of an access member according to the present disclosure. In FIG. 2a, each of the inside handle assembly 12a and the outside handle assembly 12b has a second handing 34b.

FIG. 2b schematically represents an inside view of the inside handle assembly 12a in FIG. 2a, and FIG. 2c schematically represents an outside view of the outside handle assembly 12b in FIG. 2a.

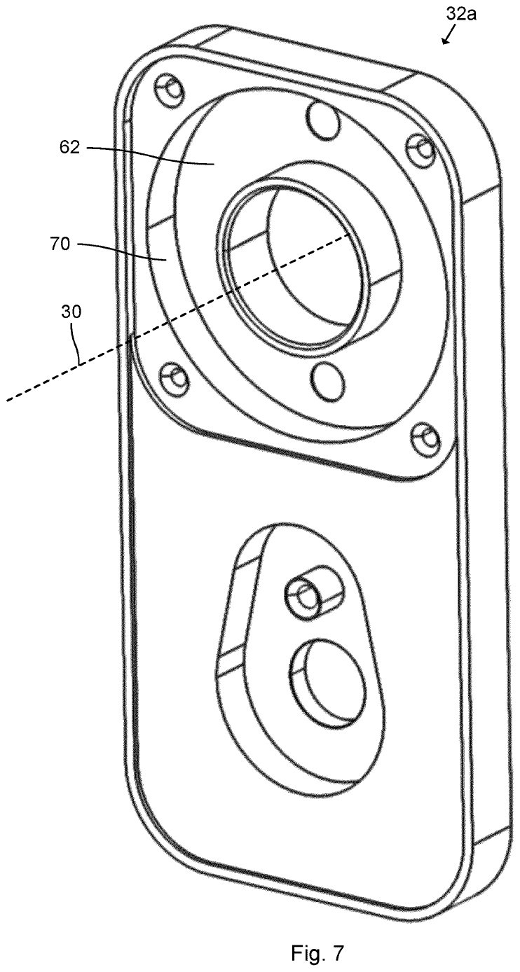

FIG. 3 schematically represents a perspective outside view of the inside handle assembly 12a having the first handing 34a. The inside handle assembly 12a further comprises a handing element 38a and a spring 40a. As shown, the handing element 38a and the spring 40a are positioned inside the base structure 26a in this example.

In addition to the escutcheon 32a, the base structure 26a of this example further comprises a plate 42a. The plate 42a is one example of a cover according to the present disclosure. When the inside handle assembly 12a is installed to the door leaf 18a, the plate 42a faces and contacts the door leaf 18a. The plate 42a is secured to the escutcheon 32a, here by four plate screws 44. The plate 42a of this example has a main extension transverse to the rotation axis 30.

The plate 42a comprises a primary cover hole 46a and a secondary cover hole 46b. The primary cover hole 46a and the secondary cover hole 46b are further examples of a primary base hole and a secondary base hole, respectively, according to the present disclosure. The primary cover hole 46a and the secondary cover hole 46b of this example are through holes for receiving the first screw 24a and the second screw 24b, respectively, therethrough.

The base structure 26a further comprises a first stop 48a and a second stop 48b. In this example, the first and second stops 48a and 48b are provided in the plate 42a.

The inside handle assembly 12a of this example further comprises an input member 50. The input member 50 is here exemplified as a shaft fixed to the handle 28a and concentric with the rotation axis 30. The input member 50 comprises an opening 52. The opening 52 may be used to engage a shaft (not shown) of the lock device 14.

FIG. 4 schematically represents a partial perspective outside view of the inside handle assembly 12a in FIG. 3. The view in FIG. 3 differs from FIG. 4 in that the plate 42a has been removed to show the handing element 38a, the spring 40a and here also the input member 50 more clearly. In FIG. 4, the handing element 38a is in a first handing position 54a. In the first handing position 54a, the handing element 38a contacts the first stop 48a. When the handing element 38a adopts the first handing position 54a, the inside handle assembly 12a adopts the first handing 34a.

The handing element 38a of this example comprises an engaging structure 56. The engaging structure 56 is here a protruding structure arranged to engage the first stop 48a and the second stop 48b, respectively. The engaging structure 56 of this example comprises a first section 58a, a second section 58b, and a tab 60 between the first section 58a and the second section 58b. In the first handing position 54a of this example, the first section 58a contacts the first stop 48a. As shown in FIG. 4, the tab 60 of this example extends substantially in parallel with the rotation axis 30.

The base structure 26a of this example further comprises an aperture 62. As shown in FIG. 4, the handing element 38a is seated in the aperture 62. The handing element 38a of this example has a substantially cylindrical shape and is concentric with the rotation axis 30.

The handing element 38a of this example comprises a first handing hole 64a and a second handing hole 64b. In the first handing position 54a of the handing element 38a when the first section 58a contacts the first stop 48a, the first handing hole 64a is aligned with the primary escutcheon hole 36a and the primary cover hole 46a, and the second handing hole 64b is aligned with the secondary escutcheon hole 36b and the secondary cover hole 46b. The first screw 24a can now be inserted, in order, through the primary escutcheon hole 36a, the first handing hole 64a and primary cover hole 46a. The second screw 24b can now be inserted, in order, through the secondary escutcheon hole 36b, the second handing hole 64b and the secondary cover hole 46b.

As shown in FIG. 4, the spring 40a encloses the input member 50 and the spring 40a is received inside the handing element 38a. The spring 40a is here exemplified as a torsion spring.

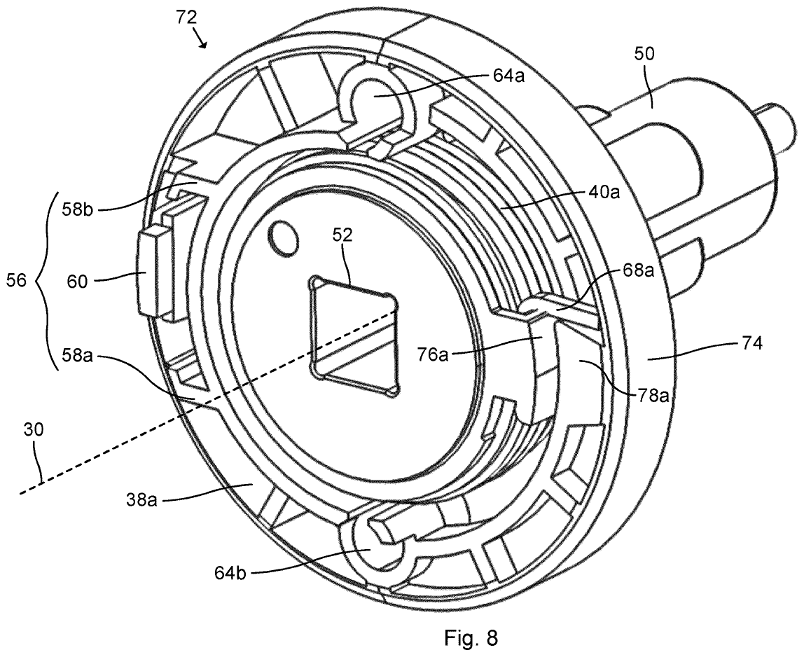

FIG. 5 schematically represents a perspective view of the spring 40a. The spring 40a of this example comprises a coiled portion 66, a first leg 68a and a second leg 68b. The coiled portion 66 of this example encircles the input member 50 and is concentric with the rotation axis 30.

The spring 40a and the handing element 38a have approximately equal lengths along the rotation axis 30. For example, a length of the coiled portion 66 along the rotation axis 30 may differ less than 50% of a length of the handing element 38a along the rotation axis 30. This contributes to a compact design.

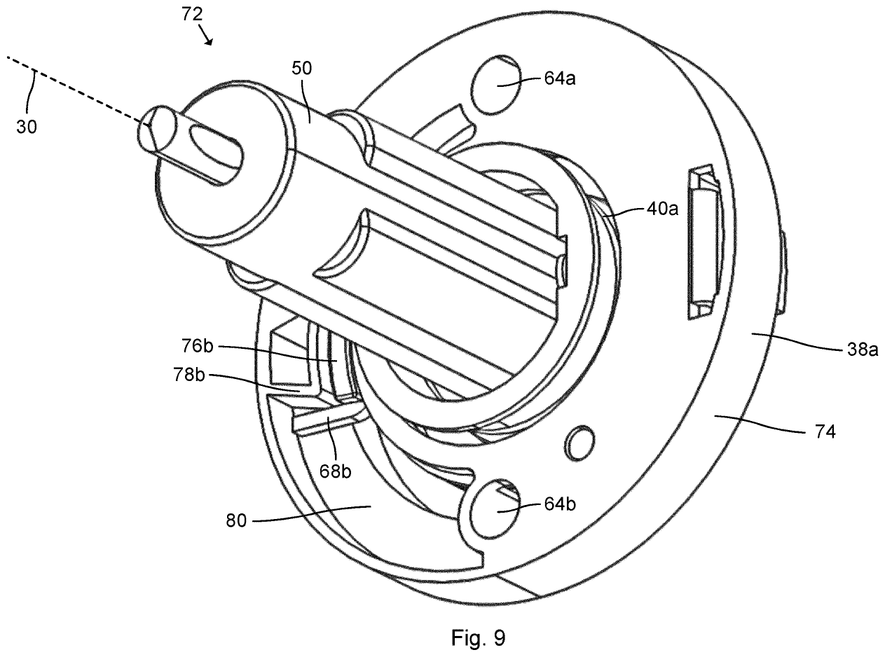

FIG. 6 schematically represents a perspective inside view of the plate 42a. The plate 42a of this example is made of sheet metal. In FIG. 6, the first and second stops 48a and 48b can be seen more clearly.

FIG. 7 schematically represents a perspective outside view of the escutcheon 32a. In FIG. 7, the aperture 62 can be seen more clearly. The aperture 62 is provided within a circular inner surface 70.

FIG. 8 schematically represents a perspective outside view of a handing mechanism 72, and FIG. 9 schematically represents a perspective inside view of the handing mechanism 72. With collective reference to FIGS. 8 and 9, the handing mechanism 72 comprises the handing element 38a, the spring 40a and the input member 50. The handing element 38a comprises a circular outer surface 74 concentric with the rotation axis 30. The outer surface 74 of the handing element 38a is in sliding contact with the inner surface 70 of the escutcheon 32a. A sliding contact bearing is thereby provided for rotationally supporting the handing element 38a for rotation about the rotation axis 30 relative to the base structure 26a.

In FIG. 8, the engaging structure 56 can be seen more clearly. FIG. 8 also shows that the input member 50 comprises a first input spring structure 76a for engaging the first leg 68a. Moreover, the first leg 68a engages a first handing spring structure 78a of the handing element 38a. The first input spring structure 76a is here integrally formed with the input member 50. As one alternative, the first input spring structure 76a may be provided by a separate component that is fixed to the input member 50 or fixed directly to the handle 28a.

FIG. 9 shows that the input member 50 comprises a second input spring structure 76b for engaging the second leg 68b. Moreover, the second leg 68b engages a second handing spring structure 78b of the handing element 38a.

When the handing element 38a is fixed to the base structure 26a, the input member 50 can rotate relative to the handing element 38a against a deformation of the spring 40a. In case the handing element 38a is rotated counterclockwise about the rotation axis 30 as seen in FIG. 9, the second input spring structure 76b and the second leg 68b travel along a recess 80 in the handing element 38a.

Due to the first stop 48a, the handing element 38a can easily be positioned in the first handing position 54a such that the first handing hole 64a is aligned with the primary escutcheon hole 36a and the primary cover hole 46a and such that the second handing hole 64b is aligned with the secondary escutcheon hole 36b and the secondary cover hole 46b. The first screw 24a can now easily be inserted through the primary escutcheon hole 36a, the first handing hole 64a and the primary cover hole 46a, and the second screw 24b can now easily be inserted through the secondary escutcheon hole 36b, the second handing hole 64b, and the secondary cover hole 46b. The first and second screws 24a and 24b can then be tightened to secure the base structure 26a to the door leaf 18a and to lock the handing element 38a against rotation about the rotation axis 30.

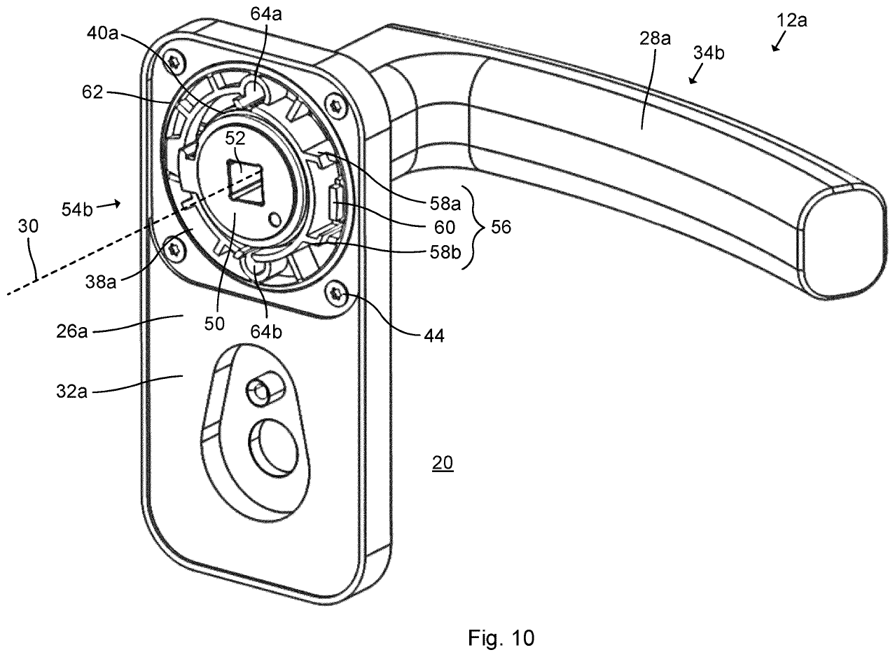

FIG. 10 schematically represents a partial outside view of the inside handle assembly 12a having the second handing 34b. In FIG. 10, the handing element 38a is in a second handing position 54b. Before the handing element 38a is fixed, the handle 28a has been rotated, e.g. manually by an installer, together with the input member 50, the spring 40a and the handing element 38a such that the handing element 38a rotates about the rotation axis 30 from the first handing position 54a to the second handing position 54b. In the second handing position 54b, the handing element 38a contacts the second stop 48b. When the handing element 38a adopts the second handing position 54b, the inside handle assembly 12a adopts the second handing 34b.

The handle 28a can thus be manually rotated to provide a desired handing 34a and 34b during installation. Due to the first stop 48a and the second stop 48b, rotation of the handle 28a is limited to 180 degrees about the rotation axis 30. The installer installing the inside handle assembly 12a does not have to think about the functionality of the handing element 38a. The installer will however feel when the handing element 38a engages the respective first and second stops 48a and 48b when the handle 28a is rotated to provide the first and second handings 34a and 34b.

The handing mechanism 72 will rotate together with the handle 28a. Thus, the input member 50, the spring 40a and the handing element 38a rotate together with the handle 28a. When the desired handing 34a or 34b is set, the handing element 38a is rotationally fixed with respect to the base structure 26a, for example by inserting the first screw 24a and the second screw 24b. When the handing element 38a is locked against rotation about the rotation axis 30, the handle 28a can be rotated in both directions about the rotation axis 30 against deformation of the spring 40a.

In the second handing position 54b of this example, the second section 58b of the engaging structure 56 contacts the second stop 48b. Moreover, in the second handing position 54b of the handing element 38a when the second section 58b contacts the second stop 48b, the first handing hole 64a is aligned with the secondary escutcheon hole 36b and the secondary cover hole 46b, and the second handing hole 64b is aligned with the primary escutcheon hole 36a and the primary cover hole 46a. The first screw 24a can now be inserted, in order, through the primary escutcheon hole 36a, the second handing hole 64b and the primary cover hole 46a. The second screw 24b can now be inserted, in order, through the secondary escutcheon hole 36b, the first handing hole 64a and the secondary cover hole 46b.

In the first handing 34a, a depression of the handle 28a will cause the first leg 68a to be driven by the first input spring structure 76a while the second leg 68b is held stationary by the second handing spring structure 78b. As a consequence, the spring 40a is deformed and handle return is provided when a user releases the handle 28a. The handle 28a can thus be rotated relative to the handing element 38a about the rotation axis 30 against a deformation of the spring 40a when the handing element 38a is in the first handing position 54a. In the first handing position 54a of the handing element 38a, the handing element 38a will be stopped by the first stop 48a even if the screws 24a and 24b are not mounted.

In the second handing 34b, a depression of the handle 28a will cause the second leg 68b to be driven by the second input spring structure 76b while the first leg 68a is held stationary by the first handing spring structure 78a. The spring 40a is thereby deformed and handle return is provided when the user releases the handle 28a also in the second handing 34b. The handle 28a can thus be rotated relative to the handing element 38a about the rotation axis 30 against a deformation of the spring 40a when the handing element 38a is in the second handing position 54b. In the second handing position 54b of the handing element 38a, the handing element 38a will be stopped by the second stop 48b even if the screws 24a and 24b are not mounted.

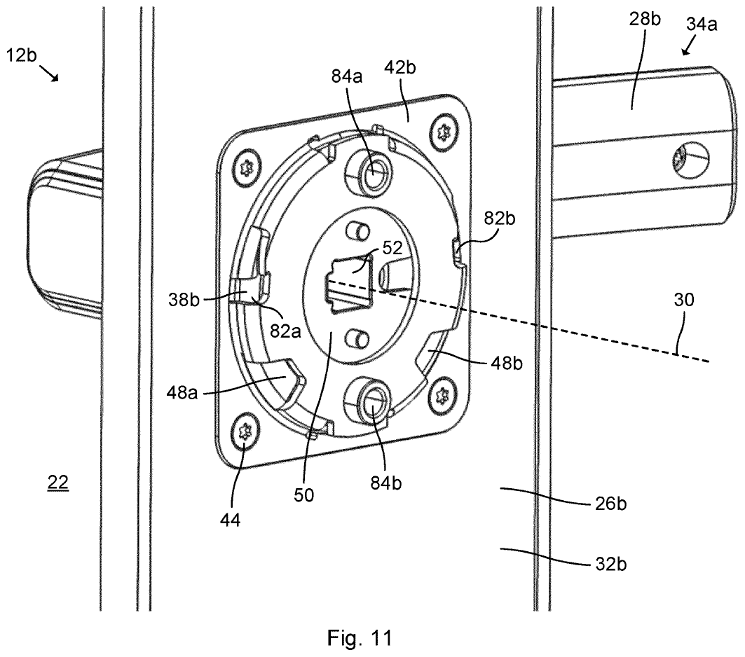

FIG. 11 schematically represents a partial perspective inside view of the outside handle assembly 12b having the first handing 34a. The outside handle assembly 12b may to a large or full extent be identic to the inside handle assembly 12a. The outside handle assembly 12b further comprises a handing element 38b. The handing element 38b may be identic to the handing element 38a.

The outside handle assembly 12b further comprises a plate 42b. The plate 42b is a further example of a cover according to the present disclosure. The plate 42b may or may not be identic with the plate 42a.

In this example, the plate 42b differs from the plate 42a by additionally comprising a first seat 82a and a second seat 82b. The tab 60 of the handing element 38b is arranged to be received by snap-fit in the first seat 82a and in the second seat 82b in the first handing position 54a and in the second handing position 54b, respectively.

The plate 42b further comprises a primary cover hole 84a and a secondary cover hole 84b. The primary cover hole 84a and the secondary cover hole 84b are further examples of a primary base hole and a secondary base hole, respectively, according to the present disclosure. Each of the primary cover hole 84a and the secondary cover hole 84b is a threaded through hole for being threadingly engaged by the first screw 24a and the second screw 24b, respectively.

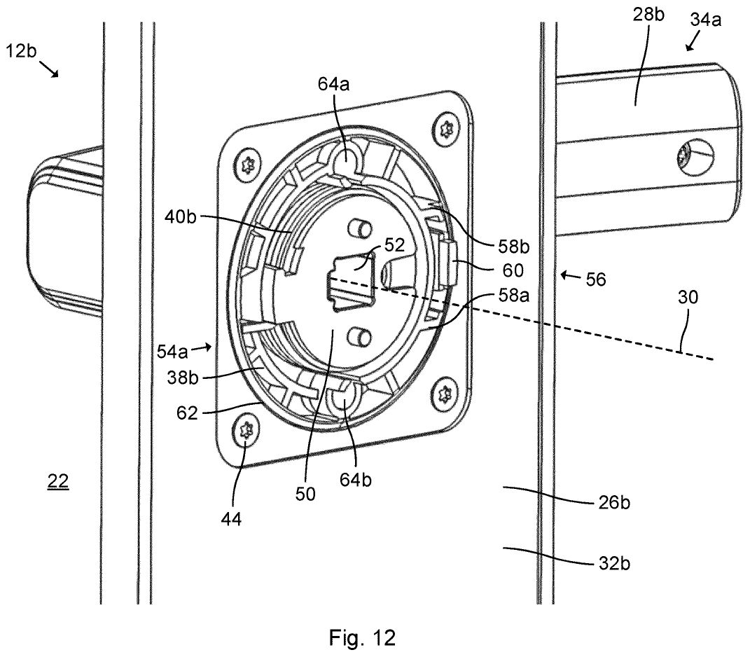

FIG. 12 schematically represents a further partial perspective inside view of the outside handle assembly 12b in FIG. 11. In FIG. 12, the plate 42b has been removed to increase visibility. The outside handle assembly 12b further comprises a spring 40b that is identic to the spring 40a.

For the first handing 34a of the inside handle assembly 12a and the outside handle assembly 12b, the first screw 24a may pass through the primary escutcheon hole 36a, the first handing hole 64a of the handing element 38a, the primary cover hole 46a, the primary cover hole 84a and into the first handing hole 64a of the handing element 38b, and the second screw 24b may pass through the secondary escutcheon hole 36b, the second handing hole 64b of the handing element 38a, the secondary cover hole 46b, the secondary cover hole 84b and into the second handing hole 64b of the handing element 38b. In case the door leaf 18a has a great thickness such that the first and second screws 24a and 24b do not reach the handing element 38b, the snap-fit between the handing element 38b and the base structure 26b is very advantageous.

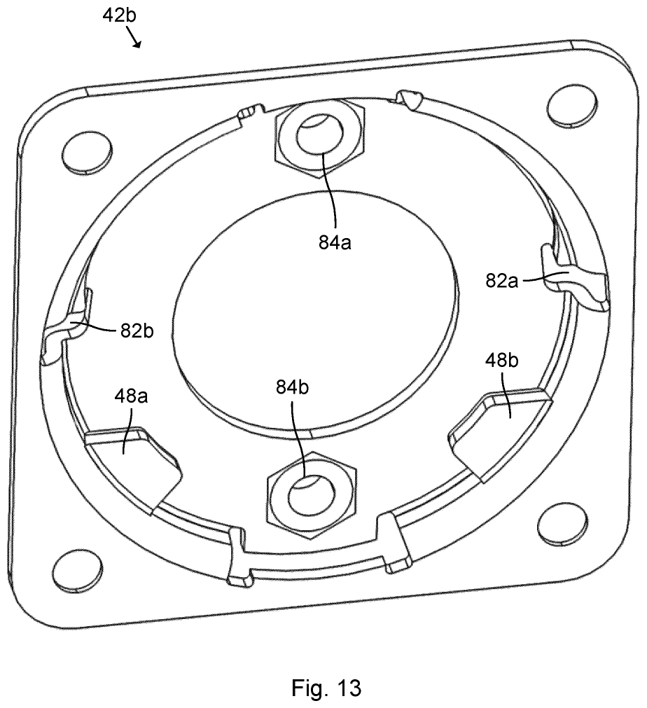

FIG. 13 schematically represents an outside perspective view of the plate 42b. In FIG. 13, the first and second seats 82a and 82b can be seen more clearly. As shown, each of the first and second seats 82a and 8b comprises an opening. In the first handing position 54a of the handing element 38b shown in FIG. 12, the tab 60 engages the first seat 82a with a snap-fit. This snap-fit can be released by inserting a screwdriver through the first seat 82a to release the tab 60.

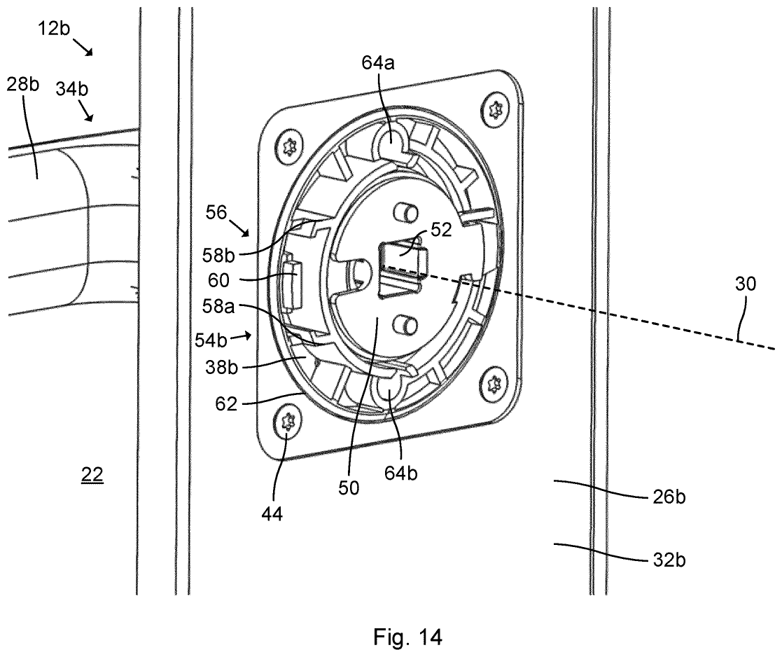

FIG. 14 schematically represents a partial perspective inside view of the outside handle assembly 12b having the second handing 34b when the handing element 38b adopts the second handing position 54b. In the second handing position 54b, the tab 60 engages the second seat 82b with a snap-fit. Also this snap-fit can be released by inserting a screwdriver through the second seat 82b to release the tab 60. The handing element 38b is thus arranged to engage the base structure 26b by snap fit in each of the first handing position 54a and the second handing position 54b.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-14. (canceled)

15. A handle assembly comprising:
a base structure for fixation to an access member;
a handing element;
a spring; and
a handle;
wherein the base structure comprises a first stop arranged to be engaged by the handing element to define a first handing position and a second stop arranged to be engaged by the handing element to define a second handing position;
wherein the handing element is rotatable relative to the base structure about a rotation axis together with the spring and the handle between the first handing position where the handing element engages the first stop and the second handing position where the handing element engages the second stop; and
wherein the handle is rotatable relative to the handing element about the rotation axis against a deformation of the spring when the handing element is in the first handing position and in the second handing position.

16. The handle assembly according to claim 15, wherein the handing element comprises an engaging structure arranged to engage the first stop in the first handing position and to engage the second stop in the second handing position.

17. The handle assembly according to claim 16, wherein the engaging structure is a protruding structure arranged to engage the first stop and the second stop, respectively.

18. The handle assembly according to claim 15, wherein the base structure comprises an aperture, and wherein the handing element is seated in the aperture.

19. The handle assembly according to claim 15, wherein the base structure and the handing element form a sliding contact bearing for supporting the handing element during the rotation relative to the base structure.

20. The handle assembly according to claim 15, wherein the handing element is rotatable at least 150 degrees between the first handing position and the second handing position.

21. The handle assembly according to claim 15, further comprising an input member fixed to, or integrally formed with, the handle, wherein the spring encloses the input member, and wherein the handing element encloses the spring.

22. The handle assembly according to claim 15, wherein the base structure comprises an escutcheon.

23. The handle assembly according to claim 15, wherein the base structure comprises a cover.

24. The handle assembly according to claim 15, wherein the base structure comprises an escutcheon and a cover, wherein the cover is secured to the escutcheon.

25. The handle assembly according to claim 23, wherein the cover comprises the first stop and the second stop.

26. The handle assembly according to claim 15, wherein the base structure comprises a primary base hole, and wherein the handing element comprises a first handing hole arranged to be aligned with the primary base hole in the first handing position and a second handing hole arranged to be aligned with the primary base hole in the second handing position.

27. The handle assembly according to claim 26, wherein the base structure comprises a secondary base hole, wherein the second handing hole is arranged to be aligned with the secondary base hole in the first handing position, and wherein the first handing hole is arranged to be aligned with the secondary base hole in the second handing position.

28. The handle assembly according to claim 15, wherein the handing element is arranged to engage the base structure by a snap-fit in each of the first handing position and the second handing position.

29. A system comprising a handle assembly according to claim 15 as an inside handle assembly and a handle assembly according to claim 28 as an outside handle assembly.
